(19) United States
(12) Patent Application Publication
(10) Pub. No.: US 2007/0044642 A1
(43) Pub. Date: Mar. 1, 2007

(54) METHOD AND DEVICE FOR PATTERN RECOGNITION IN ACOUSTIC RECORDINGS

(76) Inventor: Rainer SCHIERLE, Vaduz (LI)

Correspondence Address: WORKMAN NYDEGGER, 60 E. SOUTH TEMPLE, SUITE 1000, SALT LAKE CITY, UT, 84111, US

(21) Appl. No.: 11/466,379

(22) Filed: Aug. 22, 2006

(30) Foreign Application Priority Data
Aug. 23, 2005 (EP) 05107730.3

(51) Int. Cl. G10H 7/00

(52) U.S. Cl. 84/616

(57) ABSTRACT

For pattern recognition in acoustic recordings, a recorded signal is decomposed into individual frequency ranges and subsequently transformed for spectral decomposition into at least one coefficient file. Here, a first transformation optimized with respect to the frequency resolution and a second transformation optimized with respect to the time resolution take place in parallel. On the basis of the coefficient file, a harmonic decomposition with pattern assignment is effected. The identified patterns can subsequently be modified and further used, for example, in the form of graphic representation or acoustic playback.

The invention relates to a method and a device for pattern recognition in acoustic recordings according to the preamble of claim 1 or 13, and a computer program product and a data structure product.

In many fields of use, there is the requirement for recognizing patterns in recordings of acoustic signals and for converting them for use. Examples of this are seismic measurements, vibration analyses in mechanical engineering, the selection of audio signals in the hearing aid range, speech analysis or the conversion of music into playable or changeable formats. The basic problem in all these areas is always the same; below, pattern recognition in recordings of pieces of music will be explained purely by way of example without justifying a limitation to this intended use thereby. The method according to the invention and the device according to the invention can also be used for solving other problems, in particular from the areas explicitly described above.

For processing acoustic recordings or audio signals, these are now generally digitized. For example, a recording is made by means of suitable sensors, the recorded signal being scanned and stored in digitized form. A much more widely used approach is conversion and storage in WAVE format. In order to permit conversion which is loss-free for the human ear and storage, sampling is generally effected at 44.1 kHz and 16 bit resolution, so that the Nyquist theorem is fulfilled for the maximum frequencies acceptable by the human ear.

In this format, all acoustically relevant components are therefore detected so that playback without detectable loss is possible for the human ear. However this format requires a large storage space, which, for example, is disadvantageous for transmission in the Internet since long transmission times are the result. Moreover, there is no storage of resolved patterns, i.e. separation of, for example, various musical instruments does not take place, so that, for example, no easy modification of the recording is possible, for example, by deleting an instrument.

A further data format which incorporates so to speak the opposite information content is the MIDI format, MIDI representing Musical Instrument Digital Interface. This format developed for data exchange between synthesizers transmits not audio data but control signals which can be played back by a synthesizer or represented graphically or visually. In the widely used GM standard, coding or subsequent playback in 128 timbres is effected. Owing to the consequently comparatively small quantity of data, this format is suitable for transmission on the Internet. However, the small bandwidth of timbres cannot reproduce the natural sound. In addition, there is a dependence of the playback on the hardware in the case of the MIDI format.

The prior art follows various approaches which permit pattern recognition in audio signals, conversion from wave files to MIDI files frequently being effected.

For example, U.S. Pat. No. 6,140,568 discloses a system and a method for automatic recognition and identification of a multiplicity of frequencies which are simultaneously present in an audio signal, such as, for example, duration, amplitude and phase of these frequencies. Harmonic components are filtered out of these frequencies for determining the fundamental frequencies. The system comprises a computer-readable medium with executable code for decomposition of the signal into its sinusoidal components by calculation and comparison between the input signal and sinusoidal waves with different combinations of phase and amplitude. The system also uses various optimization and error correction routines.

The document U.S. Pat. No. 6,355,869 B1 describes a method and a system for producing notes from a recording of music and producing an editable music format. The method is based on the storage of the music recording as a wave file, from which a pseudo-wave file is generated for each relevant section in the recording. For each pseudo-wave file, a sequence file is produced, from which in turn a list of events is generated. This list is converted into an MIDI file or another note-readable file and imported into a note program for printing out the notes.

While pattern recognition for various types of pattern or identification of a large number of musical instruments can be performed by means of approaches of the prior art, some pattern types continue to present problems. Thus, particularly the percussion components in audio signals can be resolved only poorly and represented in notes by methods to date. The problem in the case of percussion is that this gives a broad range of spectral contributions which cannot be unambiguously separated and analyzed by the methods to date.

In addition, with regard to data management, the widely used MIDI format permits only storage or playback, which has major disadvantages with regard to the original sound quality.

The object of the present invention is therefore to provide an improved method or an improved device which also permits the resolution of components having a broad range of spectral contributions.

A further object of the invention is also to permit identification of percussion components in recordings of music.

A further object of the invention is to permit improved interactive changeability of acoustic recordings.

A further object of the invention is to provide a data structure product which permits playback as faithful as possible to the original with storage of control signals, so that, for example, the advantages of wave and MIDI format are combined without having to accept the disadvantages thereof.

These objects are achieved, according to the invention, by the features of the claims or by the characterizing features of the dependent claims or the achievements are developed.

The method according to the invention and the device according to the invention for pattern recognition in acoustic recordings analyze acoustic signals as detected, for example, by microphones. These signals may be pieces of music, speech, machine vibrations, seismic vibrations or other forms of mechanical vibrations.

The signal is preferably digitized after or during the recording in order to permit signal processing on computers, it being possible to effect data storage, for example, in the wave format. Alternatively, or in addition, realization of the method is also possible in the analogue technique, for example by means of an appropriate circuit.

The detected and stored signal is subsequently separated into individual frequency ranges, e.g. octaves, for which methods known per se can be used. An example of this is pyramid decomposition, in which the input signal is separated into various subband signals of different frequency ranges. Typically, the first subband comprises only the highest frequencies. The subsequent subbands then comprise the respective next lowest signal components.

The frequency ranges are subsequently spectrally analyzed, from which in each case a set of coefficients follows. According to the invention, this spectral analysis is effected in two transformation processes which are independent of one another and take place parallel and simultaneously and whose results can be mixed again.

Transformation algorithms suitable for this purpose are, for example, the Fourier transformation, fast Fourier transformation, wavelet transformation, sine transformation or cosine transformation, in particular the discrete variants being suitable.

One of the two transmission processes independent of one another is optimized with respect to the resolution as a function of time. For this purpose, the time window is chosen to be comparatively short so that the curve as a function of time is well resolved. However, the time limitation reduces the frequency resolution so that the other transformation process analyzes the same frequency range with a comparatively large time window so that a higher resolution of the frequencies is effected for this purpose. The two transformations each give a set of coefficients for the contributing frequency components. The resulting TF output image (TF for frequency time-image) is now in turn separated into subbands over time and/or time and frequency, which in turn corresponds to a transformation with longer time constants. Various frequency-time images (TF) are used for this purpose in order to detect signals or signal properties and to reconstruct original signals (input signals).

These transformations are therefore optimized for various fields of activity, such as, for example, subdivision into percussive and harmonic signal components. The Fourier transformation may be described purely by way of example as a possible transformation:
Aₛ(t,f)=∫I(t)sin(ωt)dt (1)
A_{c}(t,f)=∫I(t)cos(ωt)dt (2)
in which
Aₛ(t,f) is the sine component of the output signal,
A_{c}(t,f) is the cosine component of the output signal,
ω is the angular frequency of the frequency component to be investigated and
t is the time.

The signal stored after the transformation in the layers of the output quantity is a mixture of the transformation output signals and a pyramid decomposition of the respective next highest level of the pyramid.
TF(n,t,f)=Aₛ(t,f)\textcircled{×}A_{c}(t,f) (3)
in which \textcircled{×} is a general logic operator which in the simplest case corresponds to an addition. If contributions of next highest or upper layers are also taken into account, the result is
TF(n,t,f)=Aₛ(t,f)\textcircled{×}A_{c}(t,f)\textcircled{×}TF(n−1,t,f) (3a)
in which TF(n−1,t,f) is the contribution of the next highest layer n−1. Aₛ(t,f) and A_{c}(t,f) can usually also represent amplitudes and phase values of the Fourier transformation

$$\begin{matrix}Amp ( t , f ) = \sqrt{{{A}_{s} ( t , f )}^{2} + {{A}_{c} ( t , f )}^{2}} \\ or & ( 4 ) \\ φ = a tan ( \frac{{A}_{s} ( t , f )}{{A}_{c} ( t , f )} ) & ( 5 )\end{matrix}$$

The individual layers of the pyramid can be produced from a combination of high-pass and low-pass filters and subsampling. This TF pyramid can also be generated so as to be present as a plurality in order to take into account various purposes, such as signal analysis and signal reconstruction.

Information from one or more of the layers is combined in a filter, for example a two-dimensional filter with mean value core, to give a one-dimensional vector, from which note events can then be derived, for example, with detection of local maxima.

In addition to the arrangement comprising two transformations which are optimized, for example, for harmonic and percussive signals, it is also possible to use a scheme in which one or more transformations fill a multi-layer output range. This means that, for each octave of the subband input signal a transformation is carried out for one (1) to several (12 for an octave with semitones, 14 or 16 in order to be able to filter with filters in the frequency direction) frequencies, which produces a frequency/time image. This image can be produced from the signal of one or more transformations. Thus, for example, components from the frequency-optimized transformation can be mixed with components of the percussive transformation so that a clear delimitation between harmonic and percussive signals is possible.

After the transformation of the frequency ranges, the spectral analysis is completed by generating at least one coefficient file. In this coefficient file coefficients are taken over from the sets of coefficients of the two transformations, it being possible to select the coefficients from one of the two sets or to produce them as a mixture of coefficients. Thus, the two sets of coefficients of the different transformations are converted in an overall transformation with selection or mixing into a coefficient file, this file then containing components from both transformations.

The generation of the coefficient file utilizes heuristics, predetermined information, for example, from earlier analyses, or statistical evaluations of the actual signal. In principle, both transformation processes are applied to all frequency bands. However, it is also possible, for example on the basis of predetermined information, for only one of the two transformation processes to be used for individual frequency bands, so that only the result of this step is further used.

The selection or mixing of coefficients for generation can be effected by means of various methods.

In one approach, a first Fourier transformation is effected with a long time window and a second Fourier transformation with a short time window and subsequent low-pass filter. For the results of both transformations, in each case the real part is calculated and the ratio thereof is determined. On the basis of this ratio, a decision is made concerning the transformation from which the coefficient will be selected.

Another approach is based on the analysis of the slope in a plot of phase against frequency, i.e. the frequency-dependent slope of the phase signal. By the setting of thresholds or the calculation of a weighting parameter, a determination is effected as to which coefficient will be used or whether and how mixing of coefficients takes place.

The use of predetermined information is effected by a comparison of the sets of coefficients obtained by the transformation with a set of stored coefficients. This comparison serves as a selection criterion for the coefficients or a mixture thereof.

Finally, a file which contains the selected or mixed coefficients is generated by the complete transformation process. In addition, statistical information regarding the signal may also be stored in this file.

The harmonic decomposition which finally leads to an assignment of spectral components to patterns, such as, for example, specific musical instruments is effected on the basis of this coefficient file. After conversion, the detected patterns or events can be plotted graphically, for example as notes, or played back by synthesizer. Here, patterns or events are to be understood as meaning the characteristic components in an acoustic signal, the identification of which components is the aim of the analysis. These may be, for example, individual musical instruments, words or seismic characteristics.

According to the invention, not only the coefficients themselves but also their aggregates, for example the time integral of an amplitude for a certain frequency, or statistical information, form the basis of the decomposition.

In the simplest case, a comparison with a database in which examples of patterns are stored can be effected for the decomposition. Such databases are available, for example, for musical instruments.

A further possibility is the construction of a model for the patterns to be identified, it being possible for this model to be constructed, for example, from the actual signal using statistical methods. The model is iteratively compared with the signal and optimized stepwise. Once the remaining residual falls below a predetermined threshold value, the method is stopped and the pattern recognition is considered to be sufficiently good.

Various approaches can be used alternatively or cumulatively for feature or note recognition.

Thus, characteristic features of the individual musical instruments are determined, for example, by suitable one- or two-dimensional filters in the individual layers of the TF pyramid. These features can then be assigned directly to the individual musical instruments and their representation in notation format (e.g. Midi or internal format). Alternatively, the features are fed as input variables to a neuronal network.

In this neuronal network, those regions of the TF pyramid which are determined by the feature are investigated more exactly, for example by pixel-to-pixel comparison in a delimited environment of the feature. The determined results of the comparisons can, when fed back to the feature recognition, produce an improvement in the feature recognition. For example, feature centers, feature threshold values and frequency-time extension of the feature recognition are adapted. By means of these methods, it is possible to determine features for passive and/or harmonic sounds. Specifically, individual tones of an instrument, e.g. guitar, bass, drums and cymbals of a percussion section, but also piano and guitar chords, are recognized thereby. In fundamentally the same way, it is also possible to analyze seismic events or speech features, for example background noises to be faded out in an acoustic communication link.

Since features are often repeated in the input signals, features and patterns determined can be used for searching the total information content (TF) for such repetitions.

The patterns determined are classified according to predetermined criteria or after analysis by assignment, it being possible for this assignment to be carried out fully automatically by the computer program, semiautomatically or interactively by the program user. For improving the classification of the patterns, the quantity of results (TF) can be investigated again for comparable patterns. This method is time-saving since the transformation can often be a comparatively long-lasting process.

All methods of the prior art for music recognition have to date been linked to a static, non-interactively correctable note image which is associated with error or is incorrect in the context of the desired representation. According to the invention, methods are available for improvement which make the generated note representation modifiable by interactive specification of parameters between the computer program and the user. For example, identified harmonies (e.g. guitar and piano chords) can be improved or modified by information having a time character.

Thus, for example, the timing allocation can be manually supplemented or modified as a time classification. Notation requires classification in the time context in a manner such that note values determined can be assigned note lengths. A function in the user program permits the marking of a beginning of timing and an automatic function of the program then determines the missing timings between these markings. This process can be repeated until the allocation of timing is satisfactory. However, it is also possible to use functions which automatically recognize the allocation of timing.

An improvement of the harmony recognition by time classification is possible on the basis of a classification of the information content as timing which can be used for improving the harmony recognition by making use of the fact that, in actually played music, the harmonies often change with a change of timing.

An inadequate allocation of automatic or manual threshold values in note recognition of the prior art results in the time-consuming process of note recognition having to be restarted. According to the invention, threshold values for note recognition can also be subsequently changed so that the notes recognized can be made available to the user in optimal representation. For this purpose, criteria, for example features, are provided with a threshold value so that signals below the threshold value are not represented as musical notes and also do not sound.

By interaction with the system, the user can also affect the result through feedback. For example, he can manually specify a pre-selection of the musical instruments present from his knowledge of the cast of a music group—for example by listening to the recorded piece of music. The harmonic decomposition or the pattern recognition is then facilitated and accelerated by this specified information. The basis of this modifiability is therefore the method according to the invention, which comprises model formation using changeable coefficients, which is not or cannot be performed in the prior art.

In order to ensure optimal use and interactive modifiability, an adapted representation of the results with different elements is effected. For the selection and changing of events, an event image, for example as an image comprising groups of lines which are customary in notation, are arranged in the Y direction and correspond to tone pitches is generated. The time or a quantity proportional to the time is plotted in the X direction. Events are displayed by patterns or images obtainable by heads of notes or very generally by symbols of a font or a bitmap or other graphic format. The Y position in the image is assigned by the assignment table or a mathematical function of the properties of the event, for example the tone pitch D6 (Midi 74) as the second line from the top.

As soon as the timings have been established, the events can also be represented in customary musical notation.

A representation may also be effected in the form of lead sheets as one-page to multipage combinations of a piece of music. Lead sheets in the traditional sense are produced manually. With the method according to the invention, automatic production of lead sheets can also be carried out. For this purpose, marks which describe delimitable sections of pieces of music, for example introduction, 1st verse, 1st refrain, intermediate part, etc., are made in a piece of music. From the notes, timings and chords determined, the method then generates a combined representation of the entire piece of music or of a part of the piece of music. This representation can then be attached to the song text, this then also additionally being capable of being inserted in the note image.

By means of a threshold value controller for tone pitch, note values can be activated, displayed and converted into sound. It is possible to determine whether events are to be faded out or the tone pitch is to be shifted by a certain amount, for example an octave, with the result that the notes are then played an octave lower and are notated. This makes it possible to improve the result to such an extent that, when notes are recognized by their harmonic components they can be transposed to the fundamental frequency.

With suitable selection instruments, such as, for example, a mouse, a keyboard or another tool, individual notes or groups of notes can be selected and optionally subsequently played, for example by Midi. According to the invention, it is possible to reconstruct the original sounds which have led to the origin of the event and to play them back via the music system of the computer. These reconstructions can now also be stored separately in music files.

For a further separation into different musical instruments, note events can be selected by said methods and copied to other soundtracks or moved.

Methods which can determine a correlation of repeating patterns are available for improving the percussion result as a repeating sequence with accentuation, the correlation length being capable of being automatically determined by the algorithms of the program or by the user or by establishing the timings. Through this correlation, it is also possible to identify various parts of a piece of music. The percussion patterns thus determined are also notated as a combination on the lead sheets.

By means of the abovementioned method for recognizing percussion notes, it is possible to mark areas in TF layers from whose environment patterns can be derived. Some or all of these patterns are compared with one another, it being possible to use, for example, the method of the sum of squares of differences of superposed pixels as a criterion, which in the static case can be formulated as follows

$$S = {\sum }_{{t}_{1}}^{{t}_{2}} {\sum }_{f = 0}^{{f}_{max}} {( P ( t , f ) ⊗ R ( t , f ) )}^{2} \qquad ( 6 )$$

it being possible to formulate the corresponding dynamic case according to

$$S ( {t}_{0} ) = {\sum }_{{t}_{1} - {t}_{0}}^{{t}_{2} - {t}_{0}} {\sum }_{f = 0}^{{f}_{max}} {( P ( t - {t}_{0} , f ) ⊗ R ( t , f ) )}^{2} \qquad ( 6 a )$$

Here, P designates a signal pattern and R a reference pattern. For example, subtraction or multiplication can be used as logic operators \textcircled{×}. The reference pattern may be a pattern at another point of the TF matrix or a pattern saved beforehand or a pattern which has formed from a combination of existing patterns, for example by calculation of the mean value. In the dynamic case, the two patterns are shifted relative to one another with respect to time so that a time-dependent correspondence can be derived. In the case of small values of S, there is a great similarity of the patterns to be compared. The elements AS(i,j)=S(i,j) are in a matrix AS created from comparisons of all patterns with one another.

For classification, groups are formed and are assigned to a graph. Here, there is a link from each pattern to the pattern which is most similar. On the basis of pre-programmed features, the patterns are then classified and assigned to note values.

The recognition of chords in pieces of music is effected in the same manner as described above for percussion notes with pattern recognition.

The recognition of harmonic sounds, such as, for example, guitar, bass, piano, melody or song, makes use of threshold values. A threshold value determines whether a frequency of a TF layer is active or not. In the simplest case, each active frequency is converted into a note, position, note pitch and length, i.e. the entrance over the threshold up to the exit at the transition from active to below the threshold, being determined. This method is used, for example, for recognizing instruments which produce only a few harmonics, such as, for example, a sine wave organ.

For harmonic signals with high harmonic components (i.e. the tones are at frequencies which are a multiple of the fundamental frequency), the products
F₀→F₀\textcircled{×}(H₁+H₂+H₃+ . . . Hₙ) (7)
with F₀ as fundamental frequency and H₁,H₂,H₃, . . . Hₙ as higher harmonics, i.e. H₁=2·F₀, H₂=3·F₀ etc., are calculated for one or more layers of the TF pyramid, it being possible to use, for example, a multiplication as logic operator \textcircled{×}. Thereafter, the areas which exceed a previously determined or specified threshold value are determined as events and converted into notes.

In addition, note objects can be collected. The following properties are typically associated with each note:
position in the song
length of the event
text
frequency
note pitch
detection volume
musical instrument
amplitude
coefficients

For this purpose, it is possible to create collections of notes which are typically divided into soundtracks according to instruments. These collections can be stored in files on a computer system. Such files can also be transmitted over the Internet, via cables or by electromagnetic transmission. Http, Tcp, Https, SOAP, etc., may be mentioned as examples of transmission protocols, but it is also possible to use other formats.

The events or notes determined are displayed in one or more ways. For example, one working example represents the events as a combination of symbols (heads of notes), the vertical axis corresponding to a customary note image and the horizontal axis corresponding to the time. Since, in a standard stave with 5 lines, each line can represent three notes (e.g. g, g flat and g sharp), these states can be represented by various symbols, for example a regular head of a note for g, a triangle having a vertex pointing downwards for g flat and a triangle having a vertex pointing upward for g sharp. In addition the length of the event can be indicated by a rectangle. A further possible representation of the results is the customary notation.

In contrast to the method according to the invention, which permits adaptation of the results, methods of the prior art have the disadvantage that threshold values have to be set before the time-consuming analysis. In the case of inadequate setting, the entire analysis process has to be repeated, which is complicated, not very user-friendly, susceptible to error and time-consuming. The method according to the invention has the advantage that the threshold values for note recognition can also be set after the analysis. Consequently, the results can be adapted in real time to the user's wishes. This method combines the possibilities of note recognition with note representation in a manner which makes it possible individually to adapt the results by interaction of the program user with the analysis software.

With the special user method of semi-automatically setting the bar lines, it is possible to mark positions in the event image which musically mark the first beat of a timing. In this approach, at least one timing is set by two marks and time information is thus specified. The program then automatically calculates the missing timings for the entire song, for example with the aid of extrapolation. Deviations from the ideal result, i.e. the assumption that all timings are correctly set, often arise through the inaccuracy of the timing set and through tempo variations in the song. Additional first beats of a timing can be set by the user, the new timing layout then being recalculated in each case.

The threshold value controller described above can also be used as a tone pitch filter, i.e. an instrument for stipulating limiting frequencies, in which case note events having tone pitches above (or below or centered around) a threshold value are not displayed or even displayed and played. Alternatively, notes which are outside the threshold can be brought back into the area of the displayed events by a tone pitch transposition (octave shift). A low-pass filter in which notes above the value 60 (middle C (C5) according to Midi standard 61=cis5) are not displayed may be considered as an example. In one case, a note of tone pitch 70 is no longer displayed and/or played; in the other case, the note is transposed downward by an octave (70-12 semitone steps=58), and the note with tone pitch 58 is thus displayed and played. This method serves for reducing incorrectly recognized octave jumps in melodies in which the harmonic signals are recognized instead of the fundamental tones.

Further methods can also be used in the transformation or the harmonic decomposition. Thus, for example, coefficients of adjacent frequencies can be obtained by interpolation or by statistical methods.

It is also possible to supplement or replace coefficients by using synthetically produced coefficients or frequency components, i.e. those which are not present in the original signal, and those from earlier recordings, an earlier analysis of the same signal or mixtures thereof. Thus, for example, for a drum, upper frequency components can be artificially added from a database.

The coefficient files generated can be exported in their own format or—optionally after conversion—also in a widely used data format, such as, for example, MIDI or wave format. Equally, it is also possible to import such files and to use or modify their content in the method according to the invention.

Finally, the original or signals sounding true to the original can be produced again from the coefficients by a back-transformation, for example in wave format, which can then be played back, for example, via the computer music system and loudspeaker. In the specific case, sounds which are represented by musical notes or images of any type on the screen can be reconstructed from the TF coefficients and played.

The method according to the invention and the logical or physical connection of the device are explained in more detail below by way of example and purely schematically with reference to flow and configuration relationships of the individual components and the graphical representation on a screen.

### SPECIFICALLY

FIG. 1 shows a schematic diagram of the individual steps of the method according to the invention;

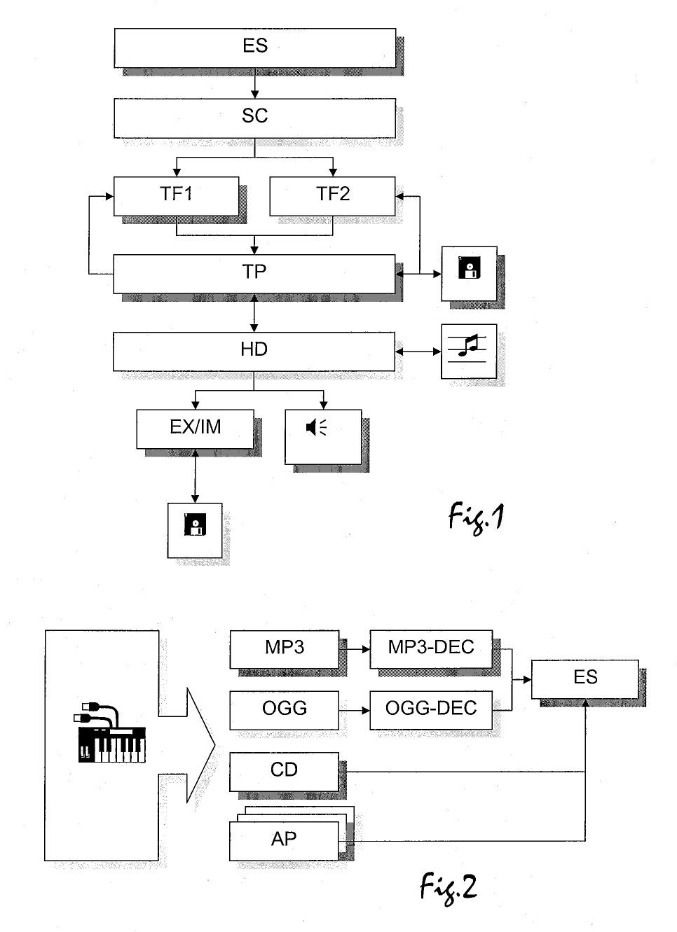

FIG. 2 shows a schematic diagram of alternatives for providing an input signal;

FIG. 3 shows a schematic diagram of the decomposition of the input signal into frequency ranges;

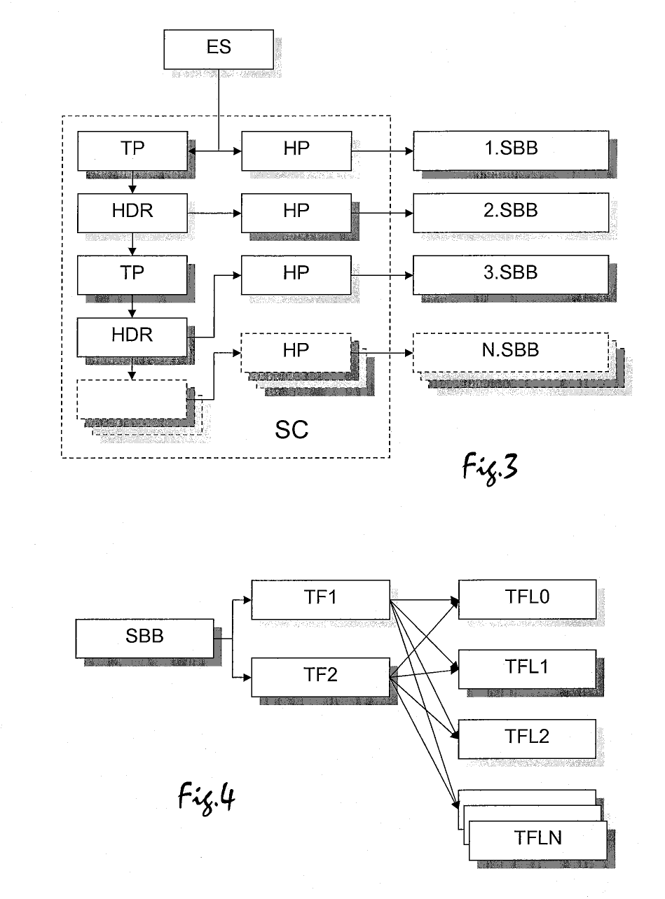

FIG. 4 shows a schematic diagram of a transformation of the frequency ranges;

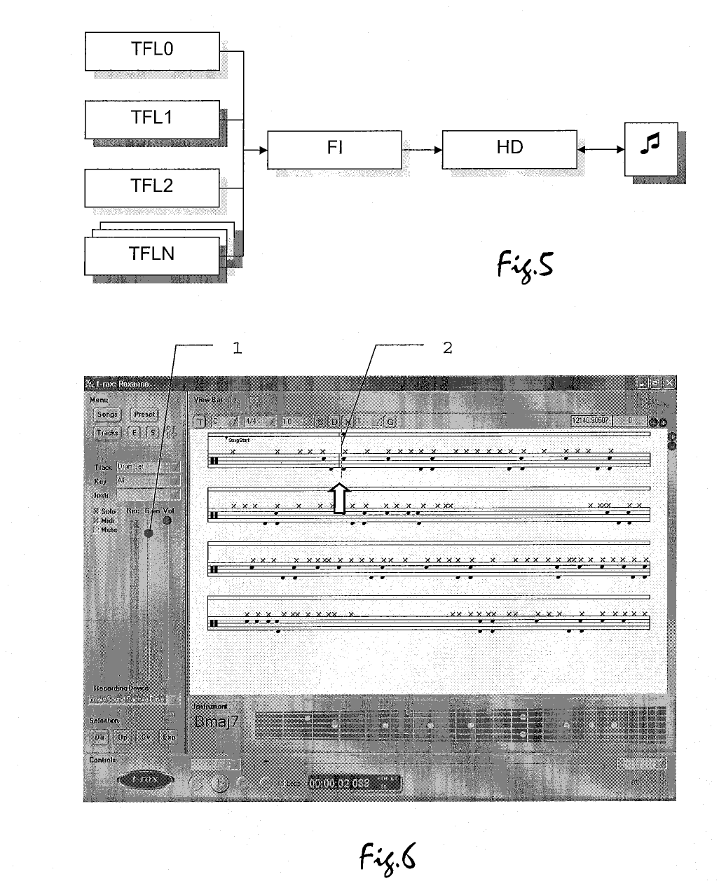

FIG. 5 shows a schematic diagram of the steps for note recognition by harmonic decomposition;

FIG. 6 shows a diagram of a graphic user interface for interactive provision of additional information;

FIG. 7 shows a diagram of a first step in a first example for interactive provision of additional information by setting of timing marks;

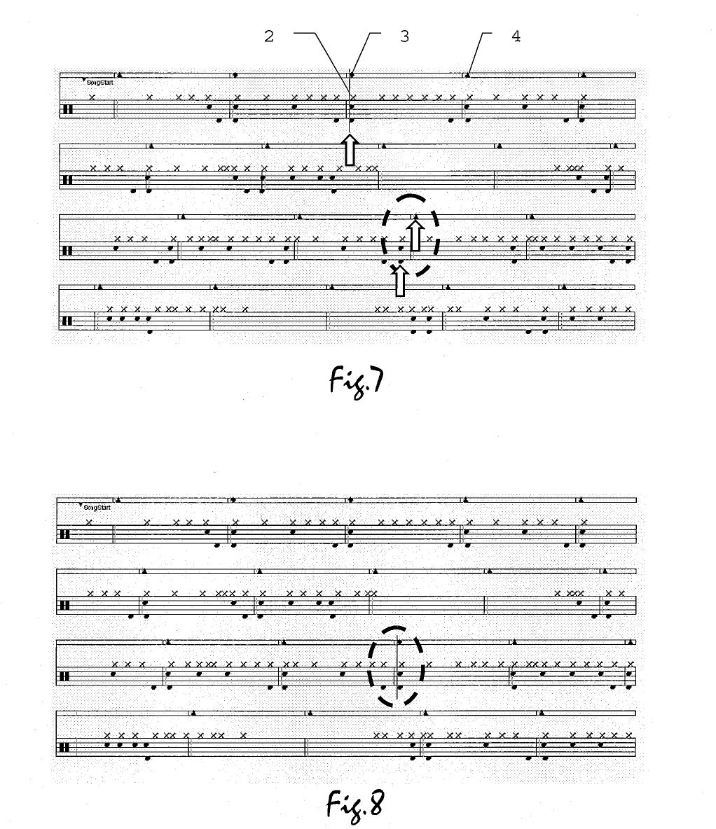

FIG. 8 shows a diagram of a second step in a first example for interactive provision of additional information by setting of timing marks;

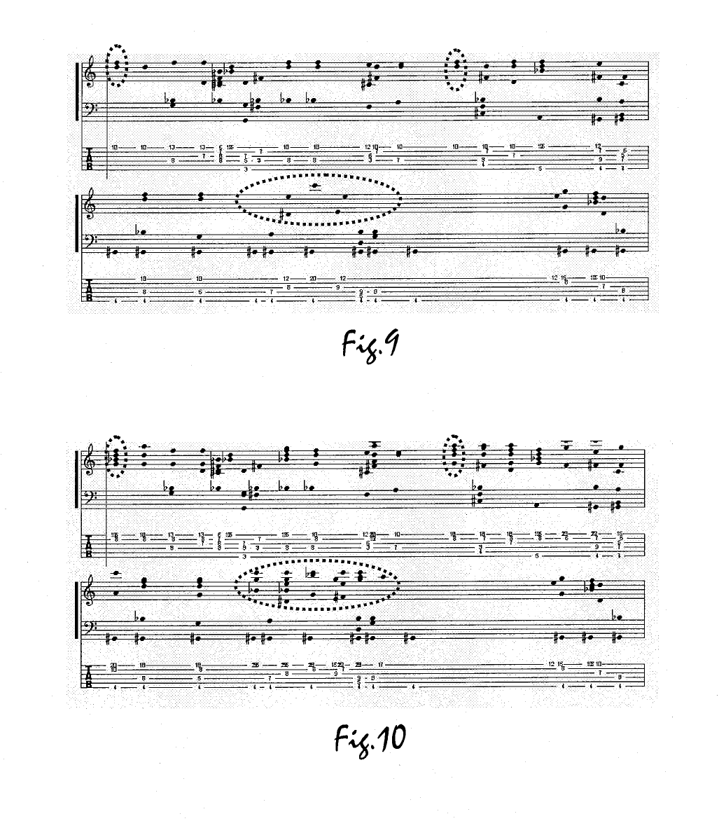

FIG. 9 shows a diagram of a first step in a second example for interactive provision of additional information by adaptation of the gain factor and

FIG. 10 shows a diagram of a second step in a second example for interactive provision of additional information by adaptation of the gain factor.

FIG. 1 shows a schematic diagram of the individual steps of the method according to the invention.

The acoustic signal is detected by a recording component or imported from a data medium and provided in the form of an input signal ES for further processing. This input signal ES is decomposed in a subband coder SC into individual frequency bands which are subsequently fed in each case to a frequency optimized first transformation TF1 and a time-optimized second transformation TF2. These transformation processes can in parallel also obtain information from the original input signal ES and use it for the transformation process.

The results of the two transformations are combined in a transformation processor TP—optionally with feedback to the first transformation TF1 and the second transformation TF2—to give a coefficient file.

On the basis of this coefficient file, the harmonic decomposition HD for recognizing patterns inherent in the input signal ES is carried out. For the harmonic decomposition HD, it is possible to use predetermined coefficients which, for example, are stored in a memory or are fed in via external data media.

By means of a graphic conversion, the identified patterns are made exportable or displayable for a graphic interface. An example of this is the conversion into notes and, for example, the printing of a score. If a representation is effected on a graphic user interface, parameters can be interactively changed or specified and further selections or modifications can be effected.

An EX/IM interface is used for transferring files. In addition, following format conversion, the acoustic representation of the pattern can be effected via an audio output which, for example, is connected to a synthesizer.

FIG. 2 shows the schematic diagram of alternatives for providing the input signal ES. The input signal can be provided by various types of sources. These include recent recording or recording taking place in real time, as well as the use of stored data. For example, signals in wave format and files of audio CDs can be used directly. Files in the formats MPx (MP3, MP4) or WMA or another format are first converted into wave files by decoders. Commercial function libraries, e.g. from the Fraunhofer Institute for MP3, are available on the Internet for this purpose. Alternatively, the coefficients of MP3 or comparable formats can be integrated directly or via a pretreatment (e.g. scaling) into one or more layers of the pyramid decomposition of the signal. Decoders for other formats, such as, for example Ogg or WMA are provided on the Internet, e.g. at www.microsoft.com.

A recording buffer AP is part of a signal recording method on the computer, for example DirectX from Microsoft. This permits, for example, recordings of signals via a microphone connected to the computer.

The decomposition of the input signal ES into frequency ranges in the subband coder SC is shown schematically in FIG. 3.

The input signal ES provided as a wave file is divided into sub-ranges or subbands SBB by suitable high-pass filters HP and low-pass filters TP and by reduction of the sampling rate, for example by halving of the data rate HDR. Typically, each subband SBB contains a bandpass-filtered version of the input signal ES. Examples of filter cores are
for low-pass {0.25, 0.5, 0.25} or {0.05, 0.2, 0.4, 0.2, 0.05} and
for high-passes, filter cores whose mean value gives the coefficient zero(0.0), e.g. {−1, 2, −1}.

Alternatively, the high-pass filter can also be omitted, with the result that a series of low-pass-filtered subbands can be produced.

FIG. 4 illustrates the transformation of the frequency ranges in a schematic diagram. The individual subbands SBB are subjected to the two differently optimized transformations TF1 and TF2 and subsequently stored in various layers TFL0, TFL1, . . . TFLN. The signal stored in the layers TFL0, TFL1, . . . TFLN of the output quantity is, for example, a mixture of the transformation output signals and a pyramid decomposition of the respective next highest level of the pyramid. Depending on the specific intended use and types of acoustic input signals ES to be processed it is also possible to carry out a different type of decomposition or multiple pyramid decomposition.

FIG. 5 shows a schematic diagram of the steps for note recognition by harmonic decomposition HD. The information present in the various layers TFL0, TFL1, . . . TFLN is combined in a filter FI and then, for event extraction, subjected to the harmonic decomposition in which the pattern recognition and model formation take place. According to the invention, a multiplicity of approaches described above can be used for this purpose. The results of the harmonic decomposition HD are represented, for example, graphically in the form of notes so that a selection or specification of information which is used again in the step of harmonic decomposition HD can be made by a user or another method.

An example of a graphic user interface for interactive provision of additional information is shown in FIG. 6. The interface provides, inter alia, a gain controller 1 and a manually changeable timing marker 2 for establishing timing.

The use of the timing marker 2 is explained in FIG. 7 in a first step of a first example for interactive provision of additional information by setting of timing marks. This approach permits a determination of all timing in the entire song. By means of the timing marker 2, the timing in the song is identified and is graphically displayed by a rhombus in the uppermost line. The actuation of a functional element then leads to conversion of the events into standard music notes, the automatically set timings being marked by triangles 4 in the uppermost line. Improvements to this method can also be achieved if the sound tracks, especially the percussion track, can be used for precise adjustment of the timings. Nevertheless because of variations in the music played, fluctuations in the recording speed or drift effects may result in calculated timings and actual patterns in the recording failing to correspond, as shown in the example within the dashed region by arrows.

By manual adaptation of the timing marking, this failure to correspond can be corrected again, as shown in FIG. 8.

FIG. 9 shows a diagram of a first step in a second example for interactive provision of additional information by adaptation of the gain factor. In this example, the threshold value controller is chosen with a threshold value greater than 0, so that only note events which are greater than the threshold value are displayed. Some relevant ranges are marked by ellipses.

In these ranges, further information is visible, as shown in FIG. 10, after changing the setting of the threshold value controller. If the threshold value controller is set to zero, all note events are visible and all events determined are displayed. By varying the threshold value controller, it is therefore possible to detect adaptation of the result without the entire method having to be carried out anew from the beginning.

1. A method for pattern assignment for acoustic recordings, comprising:
provision of a signal which represents an acoustic recording;
decomposition of the signal into frequency ranges;
transformation of the frequency ranges for spectral decomposition into at least one coefficient file, wherein, in each case for all frequency ranges, for the signal in two transformation processes independent of one another, effecting at least:
a first transformation optimized with respect to the frequency resolution and
a second transformation optimized with respect to the time resolution;
implementation of a harmonic decomposition of the coefficient file; and
pattern assignment.

2. The method as claimed in claim 1, further comprising, on transformation of the frequency ranges, effecting an optimized selection of the coefficients from the results of the first transformation and of the second transformation and/or a mixture of the coefficients from the results of the first transformation and of the second transformation.

3. The method as claimed in claim 2, wherein, on transformation of the frequency ranges:
the first transformation is effected with a longer time window and
the second transformation is effected with a shorter time window.

4. The method as claimed in claim 3, wherein the optimized selection is made on the basis of the ratio of the real parts of the first and second transformation.

5. The method as claimed in claim 2, further comprising, on transformation of the frequency ranges, effecting the selection or mixing on the basis of the frequency-dependent slope of the phase signal, in each case for the results of the first transformation and of the second transformation.

6. The method as claimed in claim 2, further comprising, on transformation of the frequency ranges, effecting the selection or mixing on the basis of comparison of the results of the first transformation and of the second transformation with a set of specified coefficients.

7. The method as claimed in claim 2, wherein said at least one the first transformation and the second transformation is effected according to at least one of the following principles:
discrete Fourier transformation;
fast Fourier transformation;
wavelet transformation;
sine transformation; and
cosine transformation.

8. The method as claimed in claim 2, further comprising, on transformation of the frequency ranges, taking into account an aggregate of the results for each transformation.

9. The method as claimed in claim 8, wherein the aggregate of the results comprises the integral for a frequency as a function of time.

10. The method as claimed in claim 1, wherein the decomposition of the signal is effected according to at least one of:
division into octaves; and
pyramid decomposition.

11. The method as claimed in claim 1, further comprising, when implementing the harmonic decomposition, making a comparison with specified coefficients, including minimization of the residual.

12. The method as claimed in claim 1, further comprising, when implementing the harmonic decomposition, making a comparison with coefficients from a preceding analysis of the signal, including coefficients derived with the use of a characteristic basic profile.

13. The method as claimed in claim 1, further comprising, when implementing the harmonic decomposition, receiving input of additional information from a user.

14. The method as claimed in claim 1, further comprising, when implementing the harmonic decomposition, using at least one of original and synthetic frequency components.

15. The method as claimed in claim 14, wherein said at least one of the original and synthetic frequency components includes upper frequency components.

16. A computer program product comprising program code, which is stored on a machine-readable medium or is embodied by an electromagnetic wave, and that, when executed, carries out a method for pattern assignment for acoustic recordings, comprising:
provision of a signal which represents an acoustic recording;
decomposition of the signal into frequency ranges;
transformation of the frequency ranges for spectral decomposition into at least one coefficient file, wherein, in each case for all frequency ranges, for the signal in two transformation processes independent of one another, effecting at least:
a first transformation optimized with respect to the frequency resolution and
a second transformation optimized with respect to the time resolution;
implementation of a harmonic decomposition of the coefficient file; and
pattern assignment.

17. A device for assigning patterns for acoustic recordings, comprising:
a recording component for recording an acoustic signal,
a subband coder for decomposing the signal into individual frequency ranges,
a transformation processor for spectral decomposition of the frequency ranges into at least one coefficient file, wherein a first transformation stage and a second transformation stage are coordinated with the transformation process, the first transformation stage effecting an optimized frequency resolution and the second transformation stage effecting an optimized time resolution; and
an export interface for exporting the coefficient file.

18. A computer-readable medium that contains a computer-readable coefficient file for use in a method for assigning patterns for acoustic recordings, wherein:
the coefficient file comprises coefficients of spectral decomposition of the acoustic signal and coordinated information for signal statistics; and
the coefficient file is adapted for use in the method, which comprises:
provision of a signal which represents an acoustic recording;
decomposition of the signal into frequency ranges;
transformation of the frequency ranges for said spectral decomposition into the coefficient file, wherein, in each case for all frequency ranges, for the signal in two transformation processes independent of one another, effecting at least:
a first transformation optimized with respect to the frequency resolution and
a second transformation optimized with respect to the time resolution;
implementation of a harmonic decomposition of the coefficient file; and
pattern assignment.
